(19) United States
(12) Patent Application Publication
(10) Pub. No.: US 2014/0200908 A1
(43) Pub. Date: Jul. 17, 2014

(54) INTEGRATION INTO MOBILE APPLICATIONS DESIGNED TO ENCOURAGE MEDICATION ADHERENCE OF A HEALTHCARE SURVEY THAT COMPENSATES USERS FOR PARTICIPATION

(71) Applicant: INTERNATIONAL BUSINESS MACHINES CORPORATION, Armonk, NY (US)

(72) Inventors: Stephen J. Moore, Austin, TX (US); Vanessa L. Wilburn, Austin, TX (US)

(73) Assignee: INTERNATIONAL BUSINESS MACHINES CORPORATION, Armonk, NY (US)

(21) Appl. No.: 13/742,813

(22) Filed: Jan. 16, 2013

(51) Int. Cl. G06F 19/00; G06Q 50/22

(52) U.S. Cl. CPC G06F 19/363; G06Q 50/22
USPC 705/2

(57) ABSTRACT

Embodiments relate to a method, system and program product, wherein in one aspect of the embodiment the method establishing communication by sending data about a user through a digital device to a source associated with a survey sponsor and providing information pertaining to an action to be completed by the user. The user is then invited user to participate in a survey once the action is completed. The user has the option to not participate in the survey. The survey provides incentives for information provided by the user and the incentives are varied in amount based on sensitivity of the information being provided, size and nature of the cohort of respondents, or value of response to survey sponsor. Analysis and results are then generated based on information provided by the user regarding the survey to the source associated with said survey sponsor.

### BACKGROUND

This invention generally relates to gathering, transmitting and receiving information relating to a user using a computing network and more particularly to integration into mobile device applications designed to encourage medication integration into mobile applications designed to encourage medication adherence of a healthcare survey that compensates users for participation.

As technology has improved, a number of applications have developed that healthcare providers use to monitor the quality of care. Such applications often allow transmission as well as receiving and sending of medical information through various telecommunication means to both health care professionals and patients. Such examples utilize wireless data communication technologies to transmit medical information. Recently efforts have been made to include many mobile applications that enable management of medical information using wireless communications.

While patients, pharmaceutical companies, physicians and other health care providers currently utilize a large number of products and systems that benefit from advances in wireless communication technology, there are still significant limitations in data gathering and transmission that benefit patients' health and treatment outcomes. There are a number of applications that have been introduced for tracking a patient's adherence to a particular medicine and even other more advanced applications that determine risk factors based on the degree of the patient's adherence. In addition, other applications have been specifically tailored to track patient's purchasing behavior. As of late, the availability of having mobile applications that provide such functions have greatly increased immediacy of patient access and improved use.

### BRIEF SUMMARY

A method, system and program product wherein the method comprises establishing communication by sending data about a user through a digital device to a source associated with a survey sponsor and providing information pertaining to an action to be completed by the user. The user is then invited to participate in a survey once the action is completed. The user has the option to not participate in the survey. However, the survey provides incentives for information provided by the user and the incentives are varied in amount based on sensitivity of the information being provided. Analysis and result is then generated based on information provided by the user regarding the survey to the source associated with said survey sponsor.

Additional features and advantages are realized through the techniques of the present disclosure. Other embodiments and aspects of the disclosure are described in detail herein. For a better understanding of the disclosure with the advantages and the features, refer to the description and to the drawings.

### DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

FIG. 1 illustrates a block diagram showing a computing environment having a facilitated network system as per one embodiment of the present invention;

FIG. 2 is a flow chart depiction illustrating a method of tracking a patient's outcome based on information provided by the patient as per one embodiment of the present invention;

FIG. 3 illustrates a mobile device display showing an offer of an incentive made to a patient for answering one or more questions as per one embodiment of the present invention; and

FIG. 4 illustrates a mobile device, showing a question posed to a patient in one embodiment of the present invention.

### DETAILED DESCRIPTION

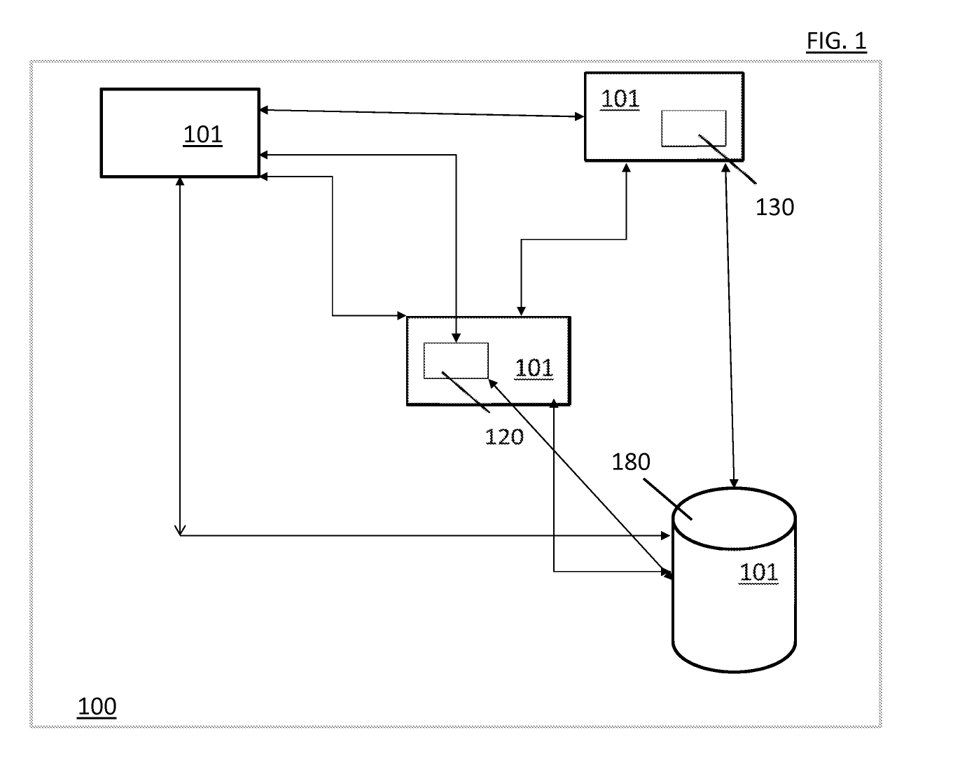

FIG. 1 is a block diagram illustration of a computing environment as per one embodiment of the present invention having a facilitated network system 100. As illustrated in FIG. 1, the system comprises a plurality of nodes 101 that are in processing communication with one another. This communication can be enabled through wired or wireless processing or other alternate means as can be appreciated by those skilled in the art. Each node 101 can also include one or more processors 130. Each node 101 can include its own internal memory as shown at 120, or be in processing communication with that node's internal memories, or in communication with one or more external memories such as the one shown in FIG. 1 at 180. The system memories 120 and 180 can also be in communication directly with one another or through the node and either be comprised of a single unit that is shared among the many nodes 101 or be comprised of a plurality of components that are in processing communication with one another. In this manner, each node 101 can either exclusively use a single memory or alternatively use multiple memories at the same time or at different times to achieve processing optimization.

In addition, the processing means through which the nodes 101 are in communication with one another are varied as can be appreciated by those skilled in the art. For example, in one embodiment, one or more nodes 101 can be in processing communication with one another using the Internet or world wide web but in other embodiments they can be part of a secured and privatized network. Each node 101 can represent a variety of digital devices, such as but not limited to mobile devices, personal computers, servers or others such devices can further include display, input/output interfaces, printers or other components as can be appreciated by those skilled in the art.

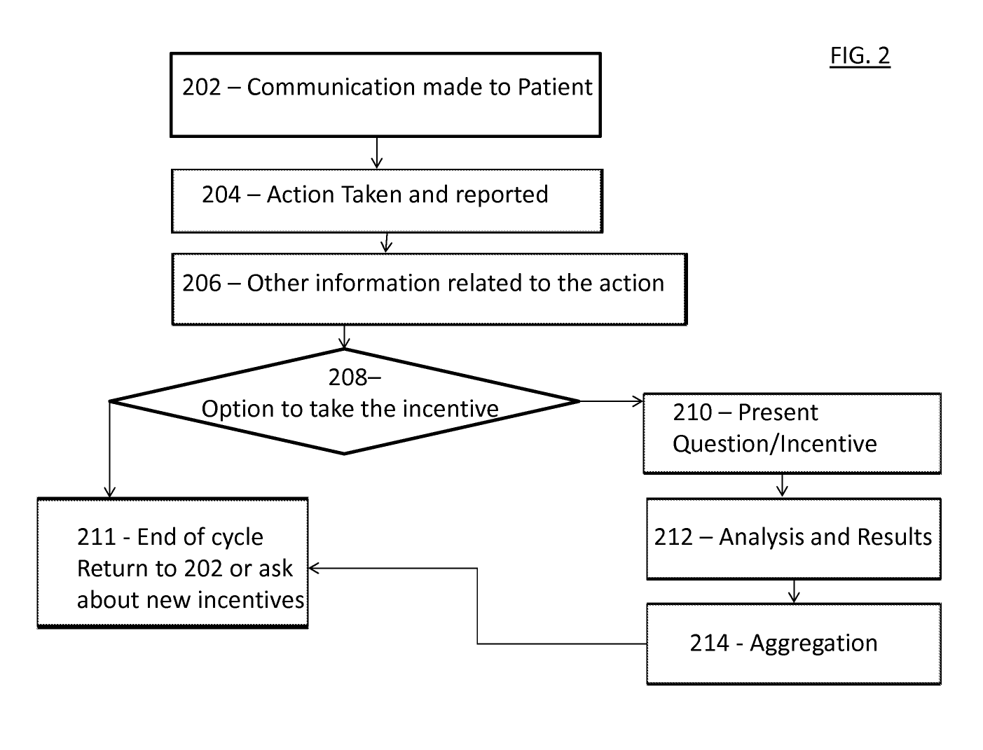

FIG. 2 is a flow chart of one embodiment of the present invention. In the embodiment shown in FIG. 2, as shown in block 202, communication is established between a digital device associated with a user such as the nodes 101 shown in FIG. 1 and a source (which can be another node shown in FIG. 1). The source can be remotely located from the user's device in one embodiment of the present invention. The source, in one embodiment is associated with a survey sponsor and the intent of the communication is to provide information about the user to the source. The information about the user may simply be user identification of the device or may include more extensive data. The communication may be established by the user identifying it to the source on its own election or because previous communication had been initiated by the source. For example, the source can randomly send information to a variety of users asking if they are willing to participate in a survey and then the communication is established consequently by the user by electing to respond to this option. Alternatively, the user is selected not randomly but from a list that has been established due a particular criteria. For example, the user can be a purchaser or a particular good, a member of a professional group, or a patient in a health care environment or one identified by a condition or disease. For ease of clarity and understanding, the latter example will be discussed, as also illustrated in FIGS. 2 through 4, with the understanding that a variety of similar options can be provided that are not patient or healthcare specific as can be appreciated by those skilled in the art.

Referring back to FIG. 2, the flow chart more particularly illustrates a tracking method for providing a patient's response to health related therapies. As discussed, in this case, block 202 establishes communication with a survey sponsor source by providing a patient data to the source associated with the survey sponsor. In one embodiment of the invention, the survey sponsor can be remote from the digital device used by the patient. In this example, the digital device used is a mobile device.

The data sent back to the source associated with the survey sponsor, can be either inputted directly by the user patient or be gathered automatically by the device and communicated back to the source associated with the survey sponsor.

In the embodiment shown in FIG. 2, block 204 then generates and communicates back to the user/patient a message for performing a certain action. In one embodiment, a patient's own digital device, such as a mobile device or a personal computer, has been programmed to provide such a message. In other embodiments, one or more nodes 101 that are in a remote location but in communication with the device, even one that is controlled by the survey sponsor can be generating the message. This process can be triggered, in one embodiment, by other nodes that may be part of a medical system that provide input; or may simply be asked for date by one or more applications that are already on the device. Poor adherence is a major health and economic problem and a patient's adherence to a treatment or medication, also referred to as compliance, concordance or capacitance has been an area that receives much attention continually. In such an example, the message to the patient may simply be to remind him/her to take a particular medication or pill at a certain time.

Once the user/patient performs the action, the user/patient then acknowledges having completed the action as shown in block 206. Other information may also be associated with the completed action and such data is also then managed such as by the user's digital device. For example, in one embodiment, the time, data, dosage and a variety of other information related to taking the pill can also be recorded and generated for later use by having the user/patient input it or by automatically generating it. This data and information can then be stored in a memory location such as discussed and provided in conjunction with FIG. 1.

As shown in block 208, the user/patient is then invited to submit additional information by providing an incentive such as compensation. In one embodiment, additional information may be information of a personal or private nature about a variety of matters ranging from behavior of user to recent or prospective purchases. Incentives may also include compensations or other similar offers that can provide value to the user. In one embodiment, the information provided can be in form of inviting the user to partake in a survey. The user also has the option of rejecting such participation. An example of this is provided in block 210. In block 210, the user/patient has the option of electing to participate or to also opt out from participating in the survey (as shown in block 211). If the user participates in the survey, the information provided through such a survey can then be stored and as necessary transmitted back to the survey sponsor. In addition, in one embodiment, the fact that user elected to opted out can also be stored and transmitted back if desired. If the survey had been completed, by answering one more questions, compensation and all incentives accumulated can also be calculated and shared with the survey sponsor, the user or other entities. In one embodiment, the information provided during the survey with or without the other components such as calculating the compensation, opting out of one or more questions or the like can then be provided in terms of result and analysis and provided back to the user, the survey provider or others. This is illustrated in block 212.

As illustrated in block 212, once the information is submitted, then analysis and results can be generated by each node or even by several nodes, for example through a node's processor(s), as per one embodiment. This information can also be stored and aggregated over time or as per a variety of other pre-elected parameters as shown in block 214. These parameters beside time can include dosage, comparison to similar user/patients or a range of factors as can be appreciated by those skilled in the art.

Referring back to blocks 208 and 210, it can be appreciated by those skilled in the art that the incentives can be provided in a variety of ways in different alternate embodiments. In the present instance, to enable clarity, a monetary incentive such as direct compensation is discussed. However, an incentive can even be provided in many different manners again as appreciated by those skilled in the art. In addition, compensation or incentives can be made available in form of credit, coupons, cash or other such incentives either by directly downloading information on the user/patient's device or by communicating to the survey sponsor's source or independent third party sources. These third party sources can include stores and pharmacies, health care providers, pharmaceutical companies or even charities. In one embodiment, information can be communicated back to the user's email, using the world wide web, or through private servers and secure networks.

In one embodiment, compensation or other incentive can be received and disbursed, as part of a survey and on a per question basis. In addition, the incentives vary based on the sensitivity of the survey. In one embodiment, the survey sponsor establishes the level of sensitivity of each question and also determines the compensation amount on a per question basis. However, as can be appreciated by those skilled in the art, other alternatives can be possible. For example a certain predetermined criteria can be established ahead of time so that questions of a certain nature or pertaining to a particular topic can be automatically deemed sensitive and be assigned at certain predetermined compensation value. The incentives and compensation can also depend on the size and nature of the cohort who could viably respond, and the value to the survey sponsor of the information obtained. Again this can be established by the survey sponsor. A cohort can be defined as an individual or a member of a particular group. In one embodiment, a cohort can be defined as a group of subjects who have shared a particular event together during a particular time span (e.g., people taking aspirin everyday between 2005 and 2006; survivors of a particular form of cancer; teachers smoked between age 30 and 40). Cohorts may be tracked over time periods in a cohort study or based on some other criteria unrelated to time. In another embodiment, cohorts can be modified by censoring so that certain inclusions or exclusions are made. For example certain individuals from statistical calculations relating to time periods (e.g. after death) or due to other conditions (misdiagnosis or recovery etc.) that would contaminate the conclusions and data can be removed from the survey sponsor's list at any time or at a later date. In another embodiment, the term cohort can also be used where membership is defined by any other factor such as those who work in a given building

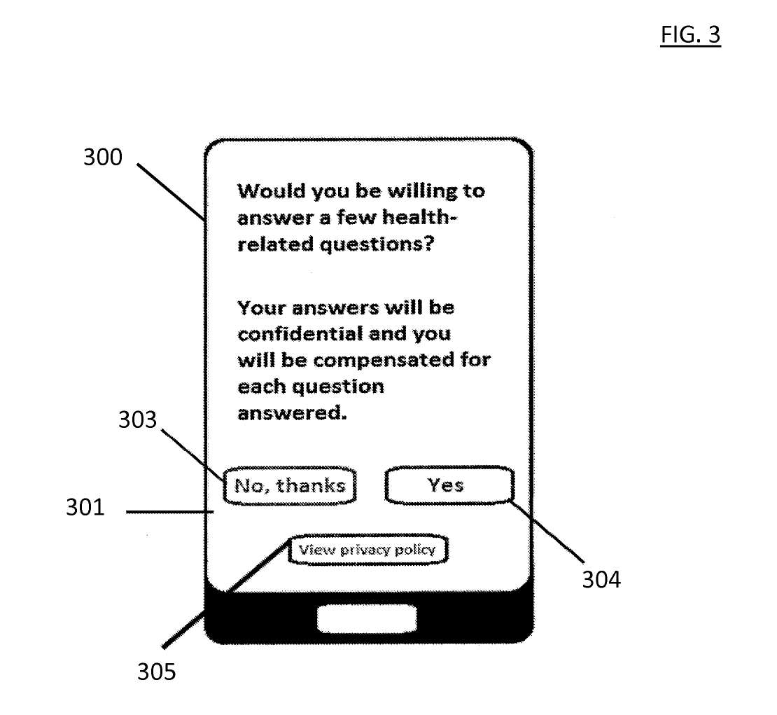

In one an embodiment, where the incentives are based on a variety of factors, the survey can be provided on a question by question basis and each question can have a different incentive or compensation value. FIG. 3 provides an illustration of one such example.

In FIG. 3, a mobile device 300 is shown having a touch screen display 301. In FIG. 3, the patient is given a choice to participate in the survey or opt out. This is shown alternatively by buttons 303 and 304 as illustrated on the display screen 301. Additional information can also be provided as indicated to enable the patient make the determination if needed. For example, in this particular case a legend is provided ensuring the patient as to the confidential nature of the information provided. In this embodiment, additional information can also be selected by way of taking the patient to other locations as illustrated on 305.

In blocks 206 and 208 of FIG. 2, additional embodiments can be added selectively to address particular needs and desires of patients and survey providers. For example, it was discussed that a scheme could be implemented where compensation can be provided on a per-question or per series basis to the patient. In such a case, the compensation can depend of a variety of factors. The factors can be preselected and established as parameters that reside in the memory location. Each parameter can then have a certain value associated with it. For example, in one embodiment, the compensation can depend on such factors as: 1) value to the survey sponsor of the information obtained; 2) the size and nature of the cohort; 3) the patient's perception of the question's sensitivity.

The amount of compensation can be calculated in a variety of manners. In one embodiment, the values are predetermined by the survey sponsor and attached to the particular question. In other embodiments, there could be a method that determines the values automatically depending on given criteria provided by the survey sponsor. For example, if a question is deemed automatically sensitive, the value of the compensation relating to the question can go up or down in a range previously set by the sponsor. In this way, there can be predetermined values stored in memory as supplied by the survey sponsor or range of values with associated programs that can alter the compensation value based on sensitivity of the survey.

The value and level of sensitivity can also be determined by the survey sponsor or be automatically generated according to particular criteria. The criteria could be previous information obtained even from previous surveys. A sensitive question, for example can be deemed as one that may appear private, stressful or sacred to the recipient of the question. For example, while a question about the current overall energy of a diabetic is not sensitive and may be compensated by only $0.05, a question about daily alcohol use of a patient with an enlarged liver condition may be deemed sensitive and be compensated at a higher rate of compensation, for example $0.50. Information about the patient being a diabetic may come from a number of sources such as the hospital, patient himself or a doctor's office. Such information can be supplied to the survey sponsor ahead of time. In one embodiment, once the information of a sensitive nature is supplied, the type of questions relating to this particular topic can then be automatically be then tagged as sensitive even without submission to the survey sponsor.

Another factor that can determine the rate or compensation of the survey is time. The survey may no longer be available after a certain time, or not responding to it for a time period can affect the rates. For example, the survey sponsor may attach a higher rate of compensation and overall value for information received regarding a patient two weeks after a particular surgery, as opposed to information received after six weeks. The patient's decision to wait an additional four weeks, if the survey is still being provided, can then lower the value attached to it. In one embodiment, the survey sponsor can provide different values associated with responding to the survey according to such delays. For example in the first week the survey is presented to the patient, question X can be worth 75 cents but a delay of two weeks may decrease the value to 50 cents. In one embodiment, this be even provided on a sliding scale or other similar basis. In the example provided, after a four week delay by the patient, for the same question, the new compensation can then be now lowered once again from 50 cents to 25 cents.

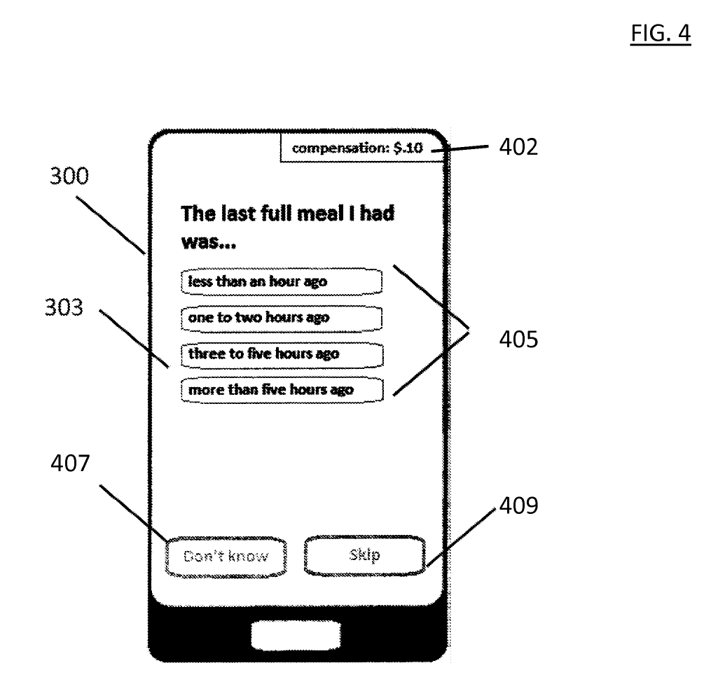

The rate of compensation may also be provided to the patient as the question is being posed so that the patient can opt out if desired. An example of this is provided in FIG. 4. In FIG. 4, the compensation amount is provided on the display as shown at 402. The question is then provided as a multiple choice option as illustrated at 405. A prompt displayed on the device can give the patient or user associated with the patient the option of either choosing to select to answer the question, respond that he or she does not know it (407) or to opt out and skip it all together as shown at 409. In one embodiment, selecting not to participate can for example return the user back to a prior activity or application on the mobile device.

The method of compensation to patients can also vary and be provided in a variety of alternate manners. For example, in one embodiment the compensation to a patient can be made as a credit provided to the local pharmacies. The pharmacy's name can be provided by the patient, be previously stored in a database as being associated with this particular patient or be selected from an on-line list previously stored and assembled. In an alternate embodiment, the compensation can be arranged as a form of credit to a particular account such as an Amazon or PayPal account. It can also be sent in a number of ways to the mobile device or even an email. In the latter condition, the compensation can be in form of a coupon or an existing account that can be later scanned at a place such as a pharmacy or a doctor's office to pay toward fees. In yet another way, the compensation can be arranged as cash or even periodic cash disbursements to the patient that can be deposited in an account or sent in form of a check to a physical address. Again the account number or the address can be provided by the patient at a previous time and stored in a memory location or be provided on a real-time basis. All information relating to payment disbursement when involving personal information of the patient is also kept confidential and private in one embodiment of the invention. Reassurance that this information is provided confidentially and even encrypted when needed can be provided and displayed to the patient prior to the disbursement and selection of the method of payment.

An additional manner of compensation to patients could be arranged as donations to charity. This method may be most appealing to certain patents and even survey sponsors. Not only this option provides an opportunity to sponsor funds to charity, especially one that provides research etc. related to the disease, but it also lessens concerns relating to privacy of compensation disbursement and certain other personal or industry specific issues. The ethical issues, for example, may concern the problems associated with the pharmaceutical companies compensating patients directly for information. The ethical issues are decreased by providing the option of the patient opting out of the survey as discussed earlier. However, the arrangement may still feel ethically fraught with either patients and/or the sponsors. Therefore, those concerns may be drastically reduced in certain instances for both parties if the survey compensation benefits a charity.

Referring back to the topic of survey questions, these questions could be created from scratch by the survey sponsor or chosen from a pool of common questions, which may be stored in a memory location. Common question may include question such as: 1) how many hours ago did you wake up?; 2) how much alcohol have you consumed? 3) are you under more stress than usual?; 4) did you gain or lose weight in the past week? Of course, these questions are only provided as way of example and as can be appreciated by those skilled in the art many other variations of such questions can be provided selectively. In one embodiment, a series of questions that are common to a type of patient, disease, condition or medication can also be selected and be put in place as part of the common questions from which the survey provider can select from. It should be noted that the survey sponsor does not necessarily need to be a healthcare facility or such organization. In one embodiment, a relative such as a parent or even the patient himself or herself may compensate the patient to adhere to good practices and want to obtain the survey results. This may be used as means to encourage or gather results that can be helpful to the patient or a larger group as a family.

The survey results may also be immediately made available to the survey sponsor or the patient or can be accumulated over time and then provided to the parties. Alternatively, both parties can be provided the information at the same time. In certain instances, other third parties may also be selectively provided such information. This can include other health professionals, insurance companies or a series of other interested entities. In other embodiments the analysis and the results may be provided to either the patient, and/or the sponsor but not both or only to a select group or subgroup including third parties. This last remark goes to the nature of how the data generated can be consumed. In most instances, unless prohibited by the law, the survey sponsor will be the owner of the data and can decide on its nature. For example, the data might become private intellectual property of a pharmaceutical firm or it might be sent as graphical information to patients and doctors to help them track outcomes and side effects. In other examples, it might be aggregated by patient advocacy groups, such as stroke and cancer research advocacy groups, to keep their constituent populations informed about promising treatments or possible side effects and problems.

Aggregation can have further advantages as it provides comparison and incentivizes patients to adhere to certain behavior over time. For example, aggregation of a patient's response to a particular question over time can allow patients to track their mood, sleep patterns, exercise regiments and so on. In addition, if the results of many patients are provided and compared to one another with respect to a certain question, a common trend or a deviation from the normal behavior of other users can pinpoint general or particular reactions to certain factors like a particular medication. For example, for a particular medication, a common response that all patients are experiencing insomnia can pinpoint a possible side effect of the medication. However, if a particular patient is experiencing a sleep pattern that is different than other patients, then the patient can be evaluated perhaps for other problems. Comparison can be provided so that the patient's age, gender or other factors are kept common in a particular survey. In another embodiment, the results may even be used in a manner to provide a drug interaction checker if more than one medication is being taken by one patient or a group of patients.

One of the issues regarding a patient's supplying of information involves privacy. To make the patient more comfortable in supplying information, safeguards can be provided in one embodiment of the invention to protect privacy. For one, in one embodiment, responses can be provided anonymously with no personally identifying information being attached to them. With respect to many uses, the data is highly valuable to the survey sponsors who can mine it for trends without any need for it being personally identifiable. In addition to the responses themselves, the survey sponsor may receive information about the medication, dosage and dosage schedule that can also be kept anonymously.

In some cases, however, patients may want the survey sponsor to know who they are. For example, the survey sponsor may be the patient's individual physician or pharmacist. In one embodiment, an initial question may be provided that asks for the patient's preference. In such an instance, before presentation of the survey and/or each question the patient may be asked indicate whether the patient wishes to remain anonymous. Even in such instances, however, additional measures can be taken to ensure that privacy is protected. For example, data encryption or alternate methods as known to those skilled in the art can be taken when the user patient does not wish to remain anonymous to still transmit the data back to the survey sponsor in a protected fashion. Additional information also may be provided on the display at time of survey taking such as the fact that the survey sponsor will not use the data provided by the patient in certain fashions or that it will not distribute it further to third parties without the consent of the patient. In alternate embodiments, the patient may be compensated more if the patient wants to share certain private information such as patient's name or any other marker that provides patient identification. Again, despite the patient actually sharing this information, the patient may still choose for this information to remain private except as with regards to the survey provider. Alternatively, the patient may choose to also share this with everyone or a particular subgroup.

Besides the identity of the patient, other information needs to be provided and the survey sponsor might pay additional or even a one time compensation for such instances. The latter case can involve, for example, information that is used to establish baseline bioinformatics for the patient such as age, gender, height, weight, race, history of illness, family medical history relating or unrelated to the illness, number of pregnancies, history of menstruation or age at menopause and other such data. In combination with real-time survey questions about mood, diet, sleep, exercise, and other such similar questions may also be asked. The survey sponsor can use such questions to provide researchers information to organize facts about drug efficacy and side effects according to population subsets. As can be appreciated by those skilled in the art, such information can also be used for a variety of different reasons in alternate embodiments. For example, researchers may learn that a particular statin medication taken soon after a meal is linked to shortness of breath in Asian men with a family history of high cholesterol. Such information allows pharmaceutical firms to design follow-up clinical trials and could ultimately allow them to target and market medications that are more effective for different subgroups. As an added benefit, identifying certain problems and side effects can also help stop the usage in instances where health hazards would be anticipated to improve overall health of patients and even avoid exposure to costly litigation. As with regular survey questions, answers to supplemental bioinformatics questions can be valuable to the survey sponsor without requiring the respondents to divulge personally identifying information.

Another problem that needs to be addressed is the possibility of the survey's manipulation in a manner that the results provided do not provide accurate information ensure best results that are not fraught with such problems, a variety of methods can be employed as can be appreciated by those skilled in the art. For example, a system may be implemented that prevents patients from replying randomly to questions simply to obtain per question rewards as quickly as possible. In one embodiment, for example, before the survey begins the application can display a screen that reminds the user that inaccurate or careless answers will lead to researchers to draw false conclusion which can in turn endanger the health of the patient or fellow patients. This solution in certain cases may help leverage the solidarity that patient feels with others suffering the same condition or illness. In a different example, similar questions can be seeded into survey to detect for randomness or sabotage. In such an example, two or more separate questions might ask the patient to assess his or her current mood on a scale, such as scale of one to five. One such question may ask “how happy do you currently feel” while a second question might ask “at this moment I feel unhappy”. Survey methodologists call these verification questions. If the answers diverge significantly from one another, the researchers might choose to disregard all answers from the particular user or patient and even stop offering the survey to that user patient entirely. In an alternate example, the users answering random questions tend to create patters of response that can be detected over time by algorithms programmed to recognize outliers in aggregate.

As discussed earlier, while embodiments were discussed in conjunction with the health care industry, as appreciated by those skilled in the art, embodiments can also apply to other industries. For example the teachings as shown in FIG. 2 can equally apply to a user of consumer goods. In such a situation, the patient is a user or even purchaser of a particular good. In the latter case, in block 202 the user purchaser either already has a mobile application on its mobile device or has been selected to receive a communication via a mobile device or even a regular personal computer. In block 204, the consumer reports back the performance of an action. In this case, the action may be either the actual purchase of a product or the response to a question or a further election provided by the survey sponsor about being interested in purchasing a particular product in the near future. Block 206 and 208 then follow similar paths of obtaining and as necessary storing additional information related to the action (in this case either actual or potential purchase of the product) and then presenting the user with a choice of participating in the survey or opting out. If the user purchaser then selects to participate in the survey, the same type of per question incentive can then be presented that can vary in amount according to the nature and sensitivity of the question asked. It should be noted that incentives other than compensation may be presented in such a case. For example, a bottle of laundry detergent may be provided as incentive to buy a washing machine, a buy one get a second one half price incentive may be provided to purchaser of a shirt, or a free manicure may be provided to the customer of a hair salon who wants to get a haircut.

In one embodiment, when the user is a patient, the intrinsic problem of following up treatment outcomes not tracked after a particular course of therapy or prescription of a medication can be addressed. It is particularly important to obtain such information, especially in real-time to not just improve treatment outcomes but also to refine labeling and avoid further medical problems and exposure to costly litigation.

The terminology used herein is for the purpose of describing particular embodiments only and is not intended to be limiting of the disclosure. As used herein, the singular forms “a”, and and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of obtaining healthcare information comprising:
establishing communication between a mobile device associated with a user and a source associated with a survey sponsor;
said mobile device providing information to said user pertaining to an action to be completed by said user regarding a medical patient which can be the user or another person;
inviting said user to participate in a survey once said action is completed by said user;
said survey presenting items that vary in sensitivity degree to said user;
providing incentives for information provided by said user that vary in value based on degree of sensitivity for information to be provided;
generating analysis and providing results based on survey information received through said mobile device regarding said user to said source associated with said survey sponsor.

2. The method of claim 1, wherein said survey includes at least one question and said information provided includes response to at least said one question.

3. The method of claim 1, wherein said compensation can be provided to said patient in form of one of the following: credit, electronic incentives, cash or check selectively provided to a location of patient's choosing.

4. The method of claim 4, wherein said compensation can be made provided to a third party of said patient's choosing.

5. The method of claim 1, wherein said survey is provided by said source associated with said survey sponsor and designed for tracking said patient's response to health related therapies.

6. The method of claim 1, wherein said degree of sensitivity is determined by said survey sponsor.

7. The method of claim 6, wherein said incentive amount is based by said survey sponsor based on said degree of sensitivity.

8. The method of claim 1, wherein said survey is presented in form of one or more questions and said incentives are provided per question.

9. The method of claim 8, wherein said based on sensitivity degree of each question asked.

10. The method of claim 9, wherein said survey degree of sensitivity of each question is determined based on perceived sensitivity to each particular user based on information relating to said user. .

11. The method of claim 1, wherein said incentive amount also varies according to size and nature of a cohort

12. The method of claim 1, said communication is initiated by an application associated to said mobile device and said application is designed to aggregate information relating to said patient to promote medical adherence to a therapy. wherein said analysis and result is communicated to said patient.

13. The method of claim 1, wherein said survey incentive amount is time dependent and is based on time of survey presentation to said patient and time of survey completion by said patient. .

14. The method of claim 1, wherein said information is aggregated based on a variety of preselected parameters and provided to at least said source associated with said survey sponsor.

15. The method of claim 1, wherein said source is located remotely and said incentives are in form of compensation.

16. The method of claim 1, wherein said questions are provided selectively by said sponsor.

17. The method of claim 1, wherein said questions are selected from a common pool of previously stored questions.

18. The method of claim 1, wherein said compensation is determined based on a said of parameters including value to sponsor, sensitivity of question to patient and size and nature of a cohort who could viably respond, and value to said survey sponsor in terms of information to be obtained.

19. A computer program product for obtaining healthcare information for tracking a patient's response to health related therapies, the computer program product comprising a computer readable storage medium having computer readable program code embodied therewith, said computer readable program code being executable by a processor to:
obtain patient data and communicate said patient data via a mobile device to a source associated with a survey sponsor;
provide information pertaining to performance of an action by said user; manage patient information once said action is completed; inviting said patient to submit additional information by providing incentives for each submitted information; said incentives varying in value depending on sensitivity of information being provided;
generate analysis and results based on said additional information and communicate said analysis and results to said mobile device.

20. A system comprising:
a processor configured to establish communication between a source associated with a survey sponsor and a mobile device associated with a particular user;
said processor in communication with an input/output interface to provide information to said particular user regarding completion of an action;
a memory in processing communication with said processor and having a list of survey questions to be presented to different users;
said processor selecting among said list of survey questions, an appropriate question to be presented to said particular user upon completion of said action;
said processor providing a compensation amount to said user, said compensation amount being determined by said processor based on a list of criteria previously stored in said memory and provided by said survey sponsor; and
said memory storing via said processor a response to said survey question provided by said particular user and said compensation amount associated with said survey question presented to said particular user.
